(19) United States
(12) Patent Application Publication
(10) Pub. No.: US 2020/0347583 A1
(43) Pub. Date: Nov. 5, 2020

(54) DEVICE COMPRISING A CONTROLLABLE VALVE, AND METHOD FOR CONTROLLING THE VALVE

(71) Applicant: OBLAMATIK AG, Chur (CH)

(72) Inventors: Roland OBRIST, Scharans (CH); Thomas KNUPFER, Chur (CH)

(73) Assignee: OBLAMATIK AG, Chur (CH)

(21) Appl. No.: 16/763,103

(22) PCT Filed: Nov. 23, 2017
(86) PCT No.: PCT/EP2017/080209

§ 371 Date: May 11, 2020

(51) Int. Cl. E03C 1/05; E03D 5/10; E03C 1/04; G05B 19/042

(52) U.S. Cl. CPC E03C 1/057; G05B 19/0426; E03C 1/04; E03D 5/105

(57) ABSTRACT

A device with a controllable valve for sanitary systems, heating systems or air conditioning systems, a control unit that controls the valve, and a sensor that is connected to the control unit. The sensor is a light sensor that can detect a light signal from visible light, convert the light signal into a sensor signal specific to the light signal, and transmit the light signal to the control unit. The control unit is adapted to control the valve based on the specific sensor signal.

### TECHNICAL FIELD OF THE INVENTION

The present invention relates to a device which comprises a controllable valve, a control unit for controlling the valve and a sensor. The sensor is connected to the control unit. The present invention further relates to a method for controlling a valve.

### BACKGROUND OF THE INVENTION

It is known to operate sanitary systems by means of electronic control devices, for example. Particularly in the case of such sanitary systems that are heavily frequented, for example in public toilets, it is desirable that the respective user can trigger predetermined functions without contact. For triggering predetermined functions, it is known to use infrared sensors, which react to the user approaching the sensor. Generally, active sensors are used which emit infrared radiation and also detect the reflected radiation. A control unit evaluates changes in the reflected radiation. In this way, a certain change in the properties of the reflected radiation can be used as a signal that a user wants to use the toilet flush, and the corresponding water valve is triggered for flushing.

In addition, infrared sensors can be used to configure operational and/or factory settings of the water valve. The disadvantage is that the specialists need an additional infrared remote control to configure. So there are additional purchase costs, and this for a device that is quickly misplaced in daily use and is therefore not immediately available at the place of use.

The configuration of the operational/factory settings of sanitary systems is also known using wireless Bluetooth or WiFi transmission technology. The configurator can configure and control the operation of the sanitary system using a handheld device, such as a cell phone or a tablet computer. However, the use of such transmission technologies is more suitable for controlling of only a few sanitary systems, such as in private households, since a separate connection must first be configured and established e.g. for each toilet, sink and shower. If there are several sanitary elements in a room, as is commonly the case in public spaces or heavily frequented sanitary facilities, the configuration of many sanitary elements in practice is often confusing and therefore complicated. A typical configurator such as a sanitary installer without special expertise in wireless transmission technologies can quickly be overwhelmed with such a complex operation.

### SUMMARY OF THE INVENTION

It is an object of the present invention to provide an easy-to-use alternative for controlling a valve, such as for sanitary, heating or air conditioning systems.

The object is achieved in that a device is provided which comprises a controllable valve, a control unit which controls the valve, and a sensor which is connected to the control unit.

The task is also solved in that a method is provided in which a corresponding device for controlling a valve is used.

In particular, the sensor is implemented as a light sensor for detecting visible light, which can trigger a defined behaviour of the liquid valve by means of the control unit based on a specific, detected light signal. The use of a light sensor, with which visible light can be detected, as well as the use of visible light as transmission technology, enables a valve configuration that is simpler than that of infrared light and that can be easily incorporated into the daily routine of an installer.

### BRIEF DESCRIPTION OF THE FIGURES

Exemplary embodiments of the present invention are explained in more detail below with reference to figures. What is shown is the following:

FIG. 1-3 simplified diagrams of exemplary sanitary systems with a controllable liquid valve according to the invention;

FIG. 4 shows an overview drawing of a control method of a liquid valve according to a first variant; and

FIG. 5 overview drawing of a control method of a liquid valve according to a second variant.

### DETAILED DESCRIPTION OF THE INVENTION

The invention relates to, amongst other things, a controllable valve 2, which can be used in particular in the sanitary, heating and/or air conditioning sector.

Both in sanitary systems 10 and in heating and air conditioning systems in particular water or aqueous solutions for used. For example, water is used in sanitary systems such as toilets or wash basins, but also in heating systems. Also, coolants are employed in air conditioners and cleaning fluids are used in sanitary systems; both cooling liquids and cleaning fluids are usually made from water and are therefore aqueous solutions.

In the context of the present description, in particular liquid valves are discussed, which serve as an example for valves 2 used according to the invention. However, other valves 2 are also suitable, for example valves for fluids, with fluids being understood as gases, liquids and/or gas/liquid mixtures. Suitable valves 2 can be valves 2 e.g. for fine-grain solids.

The passage of media or materials to be transported can be regulated in a targeted manner by using valves 2. For example, the liquid passage in sanitary systems 10, heating systems or air conditioning is regulated by liquid valves. In heating or air conditioning systems, a desired heating or cooling capacity can be set, whilst in sanitary systems 10, for example, the flush volume in toilets or urinals, or in wash basins the water volume as well as the water temperature can be set when so-called mixing valves are used.

According to the invention, a device 1 is proposed which comprises a valve 2 which can be controlled, as well as a corresponding control unit 3 for controlling this valve 2 and a sensor which is connected to the control unit 3. The behaviour of valve 2 is controlled by means of the control unit 3.

The sensor of the device 1 is a light sensor 4, which detects visible light and converts it into sensor signals for control purposes. For the purposes of the invention, the use of infrared light to control the valve is explicitly excluded (light in a wavelength range from approximately 780 nm to 1000 nm).

The light sensor 4 detects visible light. Preferably, a light sensor is used which detects essentially visible light, or a light sensor having its greatest sensitivity for light in the visible range.

A light sensor 4 is primarily understood to mean a photodetector, that is to say an electrical component which detects or receives light from the visible range and converts it into a corresponding electrical signal. Photocells such as a photodiode or a photoresistor may be mentioned as examples of light sensors 4. Therefore, preferably passive sensors or pure receivers are used.

In the context of the invention, visible light is understood to be light which is visible to the human eye. Generally, light in a wavelength range from about 350 to about 750 nm is referred to as visible light, whereby the lower and the upper limit may be subject to individual fluctuations. In particular, the sensitivity of the eye to wavelengths of the upper and lower limits are fluent; the upper limit for visible light can range from about 720 nm to about 830 nm, while the sensitivity for shorter wavelengths at the lower limit can range from 350 nm to 380 nm. However, visible light means neither infrared light (IR light) nor ultraviolet light (UV light).

Correspondingly, the light sensor 4 is adapted to detect at least light from a wavelength range between approximately 350 to 800 nm, preferably light in a wavelength range with a lower limit between about 350 nm and 400 nm, particularly preferably with a lower limit of about 350 nm to 380 nm, especially at 360 nm. The upper limit of the to be detected wavelength range is approximately between 700 nm to 830 nm, preferably between approximately 720 nm to 780 nm, in particular approximately 750 nm.

A suitable sensor is the sensor PT26-21C-TR8 from Everlight Electronics Co Ltd, or the sensor silicon NPN phototransistor SFH 3710 from Osram GmbH. If sensors are used, which can evaluate a wider wavelength range as intended for the invention, for example, the sensor used can include, for example, an additional filter unit, which ensures that this sensor can only detect and/or evaluate for the invention light with wavelengths 2 in the relevant wavelength range.

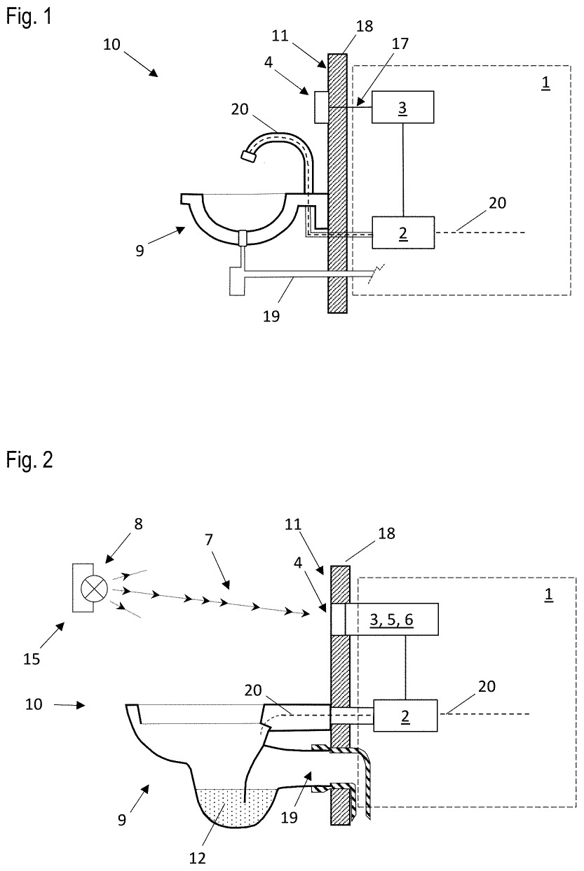

The control unit 3 of the device 1 is adapted to control the valve 2 based on the sensor signal 17 triggered by the detected light signal 7. For this control purpose the control unit 3 is connected to both the valve 2 and the light sensor 4. It can be provided that the light sensor 4 is arranged separately from the control unit 3 and the valve 2 (FIG. 1), or that the light sensor 4 is integrated in the control unit 3 (FIG. 2) thus forming a structural unit. Regardless of the connection between the light sensor 4 and the control unit 3, it can additionally be provided that the control unit 3 also forms a structural unit with the valve 2, or is arranged separately from this valve 2 in the device 1 (not shown).

A control unit 3 can be, for example, a processor that receives and processes information from other devices, such as a sensor in this case, and based on such processed information controls further devices, in this case a valve 2.

Control is understood to mean, on the one hand, the direct triggering of a specific behaviour of the (liquid) valve 2 or the triggering of corresponding settings, but also, for example, the selection, changing and/or storage of appropriate behaviour settings on the control unit 3. The term “control” is understood to mean both direct actuation of the valve 2 and the configuration of the valve settings, the configuration often being carried out before the valve 2 is assembled or actually operated, for example by an installer.

A device 1 according to the invention is shown in FIG. 1. As an example, the light sensor 4 is shown attached on a surface 11 of a mounting wall 18. A sanitary element 9 is also attached to this mounting wall 18. The device 1 and the sanitary element 9 form a sanitary system 10. In the case of FIG. 1, the sanitary element 9 is a wash basin. Alternatively, a sanitary system 10 can also comprise, for example, a toilet (see FIG. 2), a urinal, a bidet, a bath or a shower as a sanitary element 9. Not shown is a device 1, which is comprised, for example, in a heating system or an air conditioning system; nevertheless, a device 1 according to the invention is also well suited for use in heating or air conditioning systems.

Instead of being attached to a surface 11 of a mounting wall 18, the light sensor 4 can, for example, be embedded in the mounting wall 18, as shown in FIG. 2. With regard to the arrangement of the light sensor 4, it is particularly important that it can be addressed in a manner as simple as possible from a light source 8, for example a configuration device 15, and that it can be easily assigned to the corresponding sanitary element 9. The same can be applied to heating and air conditioning systems.

A mounting wall 18, as shown in FIGS. 1 to 3, is not necessary for the function of the device 1—it is used primarily in the context of technical or aesthetic needs that are independent of the invention, and only offers a suitable mounting surface for the light sensor 4 and a sanitary element 9. If it is integrated, for example, in a sanitary, heating or air conditioning system, the light sensor 4 is advantageously provided at a location that is easily accessible to an installer.

In FIG. 1 it is further shown that the sink is connected by means of liquid lines 20 with the liquid valve 2 and via this with a liquid connection (z. B. a water connection, not shown). A corresponding liquid drain 19 is also shown.

FIG. 2 shows an alternative sanitary system 10, which comprises a toilet and a device 1 according to the invention with a light sensor 4, a control unit 3 and a liquid valve controllable by the control unit 3. In contrast to FIG. 1, the light sensor 4 is shown integrated in the control unit 3, while the valve 2 is connected to the control unit 3 for control purposes.

Also shown in FIG. 2 is a configuration device 15, which comprises a light source 8. By means of the configuration device 15, defined light signals 7 are sent to the light sensor 4, which in turn are converted into corresponding sensor signals 17 by the light sensor 4 and forwarded to the control unit 3. Depending on the light signal 7, the liquid valve can be controlled directly, that is, triggered, or a specific behaviour of the liquid valve can be set, i.e. configured, on the control unit 3.

It can be provided that the control unit 3 is adapted to assign a specific action to a sensor signal 17 that is specific for the light signal 7 and that is triggered by the control unit 3. In particular, one of the following actions can be triggered:
selection of a preset assigned to the light signal 7,
processing of a preset assigned to the light signal 7,
storing a preset assigned to the light signal 7, and/or
executing a preset assigned to the light signal 7 and thus trigger a behaviour of the valve 2 defined according to the preset.

By means of a specific light signal 7, a desired behaviour setting can thus be retrieved by the control unit 3, an already stored preset can be changed and/or stored again in order to be carried out at a later time, for example. The liquid valve is therefore not necessarily triggered directly by light signals 7, but particularly, its behaviour during operation can be adjusted or set in advance by an installer and later triggered by a user.

The light sensor 4 is thus adapted to convert a defined light signal 7 of visible light falling on the light sensor 4 into a defined sensor signal 17 for the control unit 3 and to transmit it to the latter.

The control unit 3 preferably comprises a storage medium 5. At least one preset for controlling the valve 2 is stored on the storage medium 5. The preset defines a specific behaviour of the liquid valve 2 or the setting parameters required for this.

Preferably, a preset from a group is selected, which comprises:
one or more individual parameters for operating the valve 2, and
one or more preprogrammed control programs 6 for operating the valve 2, a control program 6 comprising at least two individual parameters.

A specific sensor signal 17 of the light sensor 4 is assigned to a certain setting of the liquid valve, be it an individual parameter or a combination of individual parameters to form a control program 6, which is then stored on the control unit 3 and/or is implemented by the control unit 3.

An essential aspect of the invention is that the valve 2 can be controlled by a light signal 7 from visible light falling on the light sensor 4. A specific light signal 7 can be received by means of the light sensor 4 and converted into a sensor signal 17 assigned to this light signal 7. The sensor signal 17 is transmitted to the control unit 3 and triggers the specific action on one or more presets. Presets can be called up, triggered, changed and/or stored, for example, based on the sensor signal 17.

Preferably, the light signal 7 which falls on the light sensor 4 is a signal which is selected from the following group:
a light pulse, and
a combination of two or more light pulses,

wherein each light pulse has a specific wavelength (A) or a specific wavelength range, and a specific time duration (t).

The exact embodiment of the light signal 7, in particular with regard to the number of light pulses, the length (duration) of the individual light pulses and the selected wavelengths (ranges) of the individual light pulses is used as the light code for certain behaviour settings of the valve 2. The use of a programmable light source 8 is preferred, with which not only a light code necessary for a concrete setting of the liquid valve 4 is generated and transmitted, but also with which more complex light signals 7 can be generated.

For the light signal 7, light having a specific wavelength 2 can be selected, but also light of a narrower or wider wavelength range. The selection can be colour-based, but it can also be colour-independent if, for example, so-called white light (or achromatic light) is selected. The selection of the light for the light signal 7 can be determined by the selection of the light source 8, which generates and/or emits the light signal 7. The duration of a light pulse can also be used as additional coding, as is indicated by the different arrow lengths of the light signal 7 in FIGS. 2 to 5.

By using the light sensor 4 in connection with sanitary, heating and/or air conditioning systems, the desired parameter values of a preset can be entered, changed and/or saved and/or the corresponding operation of the valve can be triggered immediately by means of the light coding.

A single parameter of a preset can be selected from a group, which includes:
an opening time of the valve 2,
an opening speed of the valve 2,
an opening angle of the valve 2,
an opening interval of the valve 2, and/or
an acoustic or visual display on the device 1.

Based on the setting of the opening time, the opening speed and the opening angle of the valve 2 the passage of a specific medium can be controlled, that is, the passage of the liquid in the case of a liquid valve. In this context, an opening time of the liquid valve denotes the time period of the actual opening, i.e. the time in which the valve is open. An opening speed is understood to mean the time duration of the opening process, that is to say the time it takes for until a certain opening angle of the valve is reached. The actual duration of the valve opening can be set based on the definition of exact delivery times (start point and end point).

Using individual parameters and/or a combination of these individual parameters to form a control program 6, for example, maximum and/or minimum values for the opening time and/or the opening range of the (liquid) valve 2 can be specified, or the following, further settings or operating modes:
a total amount of liquid or other medium to be dispensed,
a quantity of liquid or other medium to be dispensed per unit of time,
a maximum temperature of a liquid to be dispensed or other medium,
a minimum temperature of a liquid or other medium to be dispensed,
a preferred temperature of a dispensing liquid or another medium, and/or
one or more delivery times of a delivery liquid or other medium,

or any combination of these modes.

In particular, by setting maximum or minimum values, the operation of systems in public spaces can be standardized and also be better secured against abusive uses. The definition of specific delivery times is of particular interest in public toilet rooms, since time intervals for so-called stagnation flushing can be specified here. Such stagnation flushes are preferably used when regular “blind” flushing in idle mode should be triggered e.g. to prevent odours.

A device 1 as described above is particularly suitable to control or handle liquid valves 2 of sanitary systems 10, heating systems or air conditioning systems. The corresponding liquid valve 2 is in fluid connection with the corresponding elements of sanitary, heating, and/or air conditioning systems.

In these cases, the liquid valve 2 is preferably adapted as one of the following valves:
a valve for a fitting, a toilet, or a urinal or a bidet;
a mixing valve for a hand basin, a shower, a bathtub or a bidet,
a circulation valve for drinking water,
a circulation valve for a heating system, or
a valve for an air conditioning system.

For operation in the respective system the fluid valve 2 is in fluid connection with the sanitary, heating or air conditioning element as well as to a fluid/liquid supply. Typical sanitary elements 9 are, for example, toilets, urinals, wash basins, showers, bathtubs and bidets; typical heating elements are radiators and floor heating, and a typical climate element is a heat exchanger. The opening time and/or the opening range of the liquid valve 2 then determines whether and to what extent liquid is dispensed into the sanitary, heating or air conditioning element.

FIG. 2 shows an exemplary sanitary system 10 with a toilet as sanitary element 9. The toilet is attached in a known manner to a mounting wall 18 and connected with a valve 2 formed as a liquid valve, which in turn is connected to the control unit 3. The control unit 3 comprises the storage medium 5 with the presets/default settings and in this case at least one control program 6 for controlling the liquid valve based on the data coming from the light sensor 4.

In addition, a light source 8 is shown in FIG. 2, which is adapted to emit light signals 7. A configuration device 15 is also shown, which comprises the light source 8. The light source 8 is adapted for sending the light signals 7.

As mentioned, it can be provided to design the light source 8 to be programmable, so that, if necessary, a more complex light code for a specific, desired setting of the liquid valve 4 can be generated and sent out. Therefore, the light source 8 is preferably provided by a configuration device 15 with which the light source 8 can be programmed.

Such a programmable light source 8, which is particularly suitable for the present invention, is preferably selected from a group comprising:
a lamp, (e.g. a light-emitting diode—LED, or a flashlight/-lamp/-bulb), and
a display/screen.

A preferred configuration device 15, which provides the light source 8 is, for example, a portable device such as a mobile phone, in particular a so-called smartphone, a tablet computer pocket computer, but also a notebook, or another device with a programmable light source 8.

So, for example, if a cell phone is employed as configuration device 15 and its flashlight is used as light source 8, light signal 7 predominantly consists of light with a wavelength range which is specific for the flashlight of the mobile phone. Depending on the flashlight used, this can include, for example, a wavelength range between approximately 320 nm to approximately 800 nm. If a display is used, the wavelength or wavelength range that can be selected for the light signal 7 can be determined by the technology used for the display.

In fact, one of the devices mentioned above is preferred because it fulfils the technical requirements to operate its light source 8 as required, for example using an easy-to-use user interface 22 program. The use of the display itself can be particularly useful for those configuration devices which, e.g. can be operated via a user interface 22 (app), but do not feature a flashlight. A light code detectable by the light sensor 4 can thus also be emitted via a luminous frequency of the display.

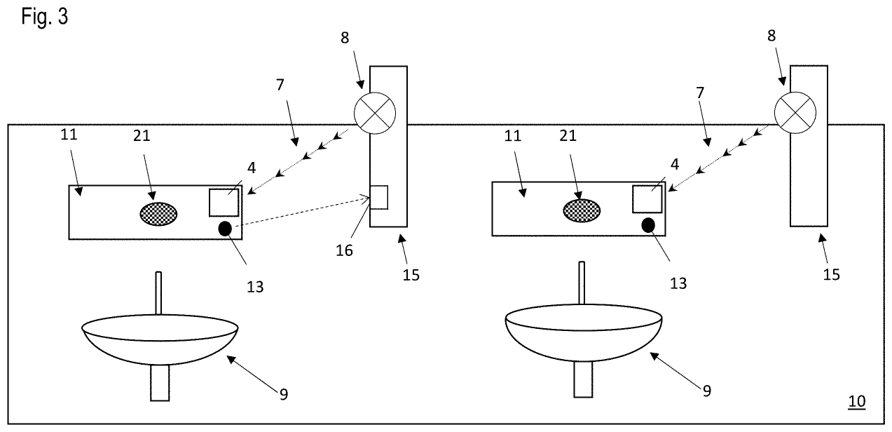

FIG. 3 shows a further exemplary embodiment of a sanitary system 10 with two sanitary elements 9 (in this case a wash basin). Each wash basin is connected with its own valve 2, in this case a liquid valve, and each liquid valve 2 is associated with a device 1 with a light sensor 4 and a control unit 3. The light sensor 4 is attached to a surface 11 of the sanitary system 10 in such a way that it can be easily addressed by a light source 8.

In addition to the sanitary systems 10 in FIGS. 1 and 2, the device 1 here optionally includes at least one own light source, which is connected to the control unit 3. The device preferably includes a corresponding indicator display 13, which can for example transmit acoustic or optical signals to the installer.

Such an indicator display 13 can, as mentioned, be a light source, for example a light emitting diode (LED) of any colour. Such an own light source or another indicator display 13 can be provided on the device 1, for example to give a colour confirmation signal when the settings transmitted by the light code have been changed or stored—the light source lights up green, for example, or lights up in a defined sequence of light pulses. Alternatively or additionally, it can be provided that the indicator display 13 emits an acoustic signal.

In the case where the device 1 features an indicator display 13, it can additionally be provided that the configuration device 15 used has its own receiver 16, which can detect a signal from the indicator display 13. Such a receiver 16 is, for example, a light sensor when a light emitting diode is attached to the configuration device 15. This is shown by way of example on the left side of FIG. 3.

The sanitary system 10 shown in FIG. 3 includes, in addition to the device 1 with indicator display 13 described above, an infrared sensor 21, preferably an active infrared sensor 21. This additional infrared sensor 21 can be provided to enable a user of the system 10 to trigger the actual operation of the liquid valve, as previously set. Since such infrared sensors 21 are often used in public sanitary systems 10—they enable the system to operate without contact—the integration of a device 1 according to the invention with a light sensor 4 for visible light has the advantage that interference between the pure “trigger signals” based on infrared and the light codes to configure the liquid valve 2 can be avoided.

The present invention also relates to a method for controlling a liquid valve 2. The method is based on the provision of a device 1 described above, which comprises a controllable valve 2, a control unit 3 which controls the behaviour of the valve 2, and a light sensor 4 connected to the control unit 3 for detecting visible light. According to the present method, the light sensor 4 is used to detect and evaluate a light signal 7 as described above, which consists of light within a wavelength range as described above. In this way, conventional programmable handheld devices such as mobile phones etc. with flashlight, LED or their display can be used to control or configure the settings for the liquid valve (see above).

A light signal 7 from visible light is detected by means of the light sensor 4. The light signal 7 is specifically for a desired setting or action of the control unit 3. The light sensor 7 converts this specific light signal 7 into a sensor signal 17 specific for this light signal and passes it to the control unit 3. The control unit 3 controls the valve 2 based on the information content of the light signal 7.

Preferably, at least one preset is stored on a storage medium 5 of the control unit 3, which, as already described, can include one or more individual parameters for operating the valve 2 and/or one or more control programs 6, which consist of at least two individual parameters.

A preset/pre-setting is preferably assigned to the specific sensor signal 17, or at least one specific action of the control unit 3. The control unit 3 then triggers based on the sensor signal specific for the light signal 7 one of the following actions, also described above: Selection of the assigned preset, editing, saving and/or executing this assigned preset or presets. A light source 8 as described above is preferably provided to carry out the method. A light source 8 that is programmable is particularly suitable, such as a light source 8 of the hand-held devices already mentioned. A cell phone is particularly suitable, in particular a so-called smartphone, which can be used as a configuration device 15 in the present method. Using a cell phone, for example, its already existing flashlight 8 or the luminosity of the display can be programmed so that the device emits a light signal 7 in a defined manner—as described as a light code. By using one or more light pulses with specific wavelengths A or wavelength ranges and specific periods of time very complex light signals 7 can be generated, so that a large number of different individual parameters or control programs 6 or actions to be carried out can be stored in relation to the respective selected parameters for specific light codes.

According to the present method, no infrared radiation is used to control the valve 2.

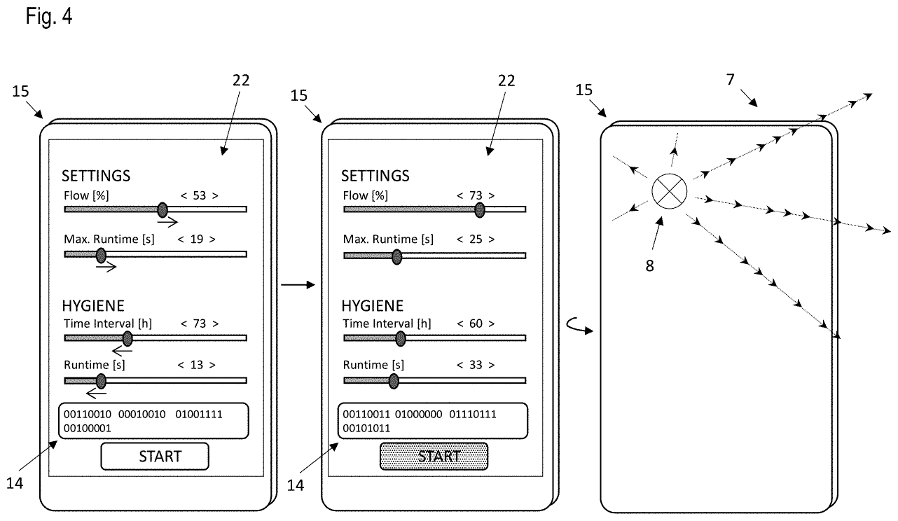

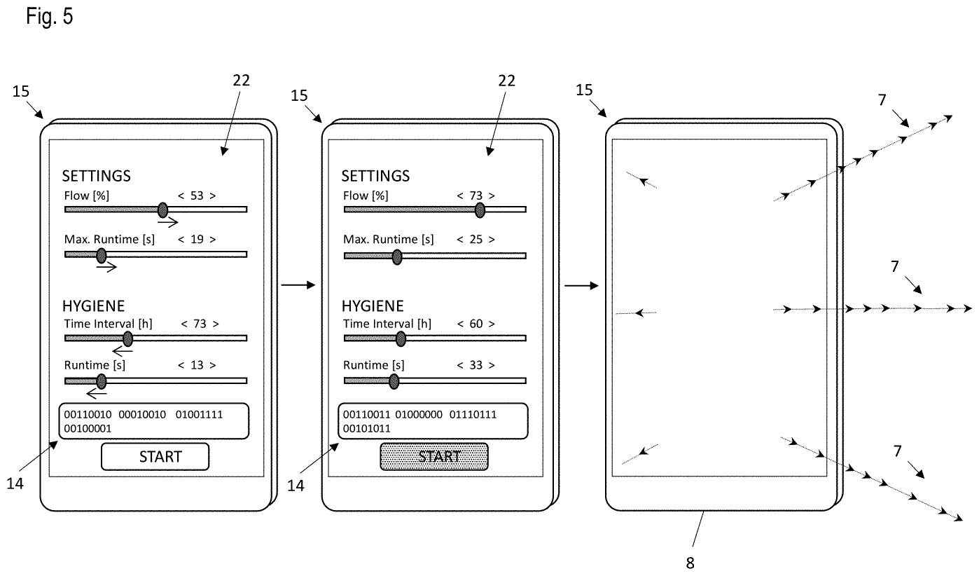

In FIGS. 4 and 5 a schematic overview of such a configuration device 15 (in these cases a mobile phone) is shown which emits a correspondingly coded light signal 7 for the light sensor 4, for example by means of a programmable flashlight 8 (FIG. 4) or a programmable display (FIG. 5). In addition, it is shown how by means of the configuration device 15, in this case a cell phone, a flashlight or a display can be programmed to trigger a desired light signal 7.

In this case, a user interface 22 is provided for programming the flashlight 8 or the display, with which a user, for example a (sanitary) installer, can enter the desired settings in the control unit 3 for the liquid valve 2. In particular, concrete parameter values can be entered using the user interface 22, whereby the provided setting options correspond to the presets/default settings on the storage medium.

According to FIGS. 4 and 5, the user interface 22 is used to program a light signal 7 of visible light specific to the desired settings on the control unit 3 and also to trigger the light signal 7. Such a user interface 22 can be, for example, a so-called graphical user interface (GUI), as is usually the case in smartphones, tablet computers or other computers.

By operating the user interface 2 for example, an installer can define the desired settings for valve 2, and the processor of the mobile phone or the software stored on the mobile phone calculates a coding 14 for the light signal 7 that corresponds to the selected settings. Only by pressing a start button, for example, will the specific light signal 7 corresponding to the settings made on the user interface 22 be emitted by the light source 8. The light signal 7 is detected by the light sensor 4 and converted by it into corresponding sensor signals 17, which in turn are sent to the control unit 3 of the device 1 and finally assigned to the respective action or the corresponding preset(s) on the control unit 3.

In FIGS. 4 and 5 it is shown by way of example that the input in the user interface 22 of the mobile telephone can take place by correspondingly moving a slide control to the position required for a desired value. FIGS. 4 and 5 show, by way of example, sliders for four different behaviour settings: flow in percent (%), maximum runtime in seconds (s), time interval in hours (h) and runtime in seconds (s). Under the point “SETTINGS” settings can be made regarding the normal operation, for example for flushing a toilet. In this case, under the point “HYGIENE” settings for a so-called stagnation flushing are made; the time interval to be set determines the number of hours after which the toilet flush, that is, when the liquid valve is activated in the idle state.

FIGS. 4 and 5 each show two different representations of the user interface 22—see the left and middle representations of the display page of the mobile phone. When comparing, it can be clearly seen that in each case changed settings on the user interface 22 lead to a changed coding 14 for the light signal 7 to be emitted. The coding 14 is shown here as a binary code, which is converted by the configuration device 15 into a corresponding light code 14. After pressing the START button (represented by the gray background of the START button), this conversion is triggered, and the respective light signal 7 is emitted according to FIG. 4 by the flashlight 8 of the mobile phone (as can be seen in the representation of the back of the mobile phone on the right side of FIG. 4), or the light signal 7 is sent by a pulsation of the display itself (as can be seen in the representation of the display of the mobile phone on the right side of FIG. 5).

As already mentioned, it can be provided that the behaviour parameters and the corresponding light code selected with the user interface 22 of the mobile phone can both change and save the associated presets/default settings or setting parameters on the control unit 3. It can also be provided that the corresponding behaviour of the liquid valve 2 is also triggered directly by means of the user interface 22, for example as a test run.

If, for example, a mobile phone is used to trigger the light signal 7, it is advantageous if the configurator aligns the flashlight 8 of the mobile phone after starting such that the triggered light signal 7 actually falls on light sensor 4 of device 1 for the entire duration of the light signal 7. In this way, it can be ensured that the light signal 7 is completely received by the light sensor 4. A start delay for emitting the light signal 7 can also be provided so that the light source 8 of the configuration device 15 can be aligned with the light sensor 4.

The advantage of the present invention is that the configurator does not have to rely on an additional device such as a remote control, but simply uses an everyday device such as a mobile phone or a tablet computer to control or configure sanitary, heating and/or toilet systems/facilities.

### LIST OF REFERENCE SYMBOLS

1 device
2 valve
3 control unit
4 light sensor
5 storage medium
6 control program
7 light signal
8 light source
9 sanitary element
10 sanitary system
11 surface of the sanitary/heating or air conditioning system
12 liquid
13 indicator display of the device 1
14 coding for light signal 7
15 configuration device
16 receiver on the configuration device
17 light sensor signal
18 mounting wall
19 fluid drainage
20 liquid lines from/to the liquid valve
21 infrared sensor
22 user interface
λ wavelength
t time

1. Device (1) comprising:
a controllable valve (2) for sanitary, heating or air conditioning systems,
a control unit (3) which controls the valve (2), and
a sensor which is connected to the control unit (3),
characterized in that the sensor is a light sensor (4), which detects a light signal (7) from visible light, converts it into a sensor signal (17) specific for this light signal (7) and sends it to the control unit (3), and in that the control unit (3) is adapted to control the valve (2) based on the specific sensor signal (17).

2. Device (1) according to claim 1, characterized in that the control unit (3) comprises a storage medium (5) on which at least one preset for controlling the valve (2) is stored, the preset being selected from a group comprising:
one or more individual parameters for operating the valve (2), and
one or more preprogrammed control programs (6) for operating the valve (2), a control program (6) comprising at least two individual parameters.

3. Device (1) according to claim 2, characterized in that the control unit (3) is adapted to assign a sensor signal (17) specific for the light signal (7) to a preset stored on the storage medium (5), wherein the control unit (3) at least can trigger one of the following actions:
selection of a preset assigned to the light signal (7),
processing of a preset assigned to the light signal (7),
storing a preset assigned to the light signal (7), and/or
executing a preset assigned to the light signal (7) and thus trigger a behaviour of the valve (2) defined according to the preset.

4. Device (1) according to claim 4, characterized in that the light signal (7) falling on the light sensor (4) is a signal which is selected from the following group:
a light pulse, and
a combination of two or more light pulses,
wherein each light pulse is visible light of a specific wavelength (λ) or a certain wavelength range, and a specific time period (t).

5. Device (1) according to claim 2, characterized in that an individual parameter is selected from a group which comprises:
an opening time of the valve (2),
an opening speed of the valve (2),
an opening angle of the valve (2),
an opening interval of the valve (2), and/or
an acoustic or visual display on the device (1).

6. Device (1) according to claim 1, characterized in that the valve (2) is a liquid valve of a sanitary system (10), a heating system, or an air conditioning system.

7. Device (1) according to claim 6, characterized in that the control program (6) defines an operating mode of the valve (2), the operating mode being selected from a group which comprises:
dispensing a total amount of a liquid (12), dispensing a total amount of a liquid (12) per unit of time,
a maximum temperature of a liquid to be dispensed (12),
a minimum temperature of a liquid to be dispensed (12),
a preferred temperature of a liquid to be dispensed (12),
one or more dispensing times and/or dispensing intervals, and/or
any combination of these modes.

8. Device (1) according to claim 1, characterized in that it comprises a configuration device (15) with a light source (8) for emitting light signals (7) which can be detected by the light sensor (4).

9. Device (1) according to claim 8, characterized in that the light source (8) is a lamp which is selected from a group which comprises one or more light-emitting diode(s) (LED(s)) and one or more flashlight(s), or that the light source (8) is a display.

10. Device (1) according to claim 9, characterized in that the configuration device (15) is selected from a group comprising:
a mobile phone,
a tablet computer,
a pocket computer, and
a notebook,
and that the light source (8) is an LED, a flashlight or a display.

11. Device (1) according to claim 1, characterized in that it comprises an indicator display (13) for emitting acoustic or optical signals, the indicator display (13) being connected to and controlled by the control unit (3).

12. Sanitary system (10) comprising:
one or more sanitary elements (9), which are selected from the following group:
toilet, urinal, sink, shower, and bidet, and
one or more devices (1) according to claim 1,
wherein a respective device (1) is assigned to each sanitary element (9).

13. Heating system comprising:
one or more heating elements, which are selected from the following group:
radiator and floor heating element, and
one or more devices (1) according to claim 1,
wherein a respective device (1) is assigned to each heating element.

14. Air conditioning system comprising:
one or more air conditioning elements, in particular one or more heat exchangers, and
one or more devices (1) according to claim 1,
wherein a respective device (1) is assigned to each air conditioning element.

15. Method for controlling a liquid valve (2), characterized in that the method comprises the following steps:
providing at least one device (1) which has a controllable valve (2), a control unit (3) which controls the behaviour of the valve (2), and a light sensor (4) connected to the control unit (3) for detecting visible light,
detecting a light signal (7) from visible light by the light sensor (4),
converting the light signal (7) into a for this light signal (7) specific sensor signal (17) by the light sensor (4),
forwarding the sensor signal (17) to the control unit (3), and
controlling the valve (2) by the control unit (3) based on the light signal (7).

16. Method according to claim 15, characterized in that the control unit (3) provides a storage medium (5) on which at least one preset for controlling the valve (2) is stored, the preset comprising:
one or more individual parameters for operating the valve (2), and/or
one or more preprogrammed control programs (6) for operating the valve (2), a control program (6) comprising at least two individual parameters.

17. Method according to claim 16, characterized in that the control unit (3) triggers one of the following actions based on the sensor signal (17) specific to the light signal (7):
selection of a preset assigned to the light signal (7),
processing of a preset assigned to the light signal (7),
storing a preset assigned to the light signal (7), and/or
executing a preset assigned to the light signal (7) and thus triggering a behaviour of the valve (2) defined according to the preset.

18. Method according to claim 15, characterized in that at least one light source (8) is provided which emits the light signal (7) to the light sensor (4), the light signal (7) being selected from a group which comprises:
a light pulse, and
a combination of two or more light pulses,
wherein each light pulse is visible light of a specific wavelength (λ) or a specific wavelength range, and a specific time period (t).

19. A method according to claim 18, characterized in that the light source (8) is provided by a configuration device (15) which is selected from a group which comprises:
a mobile phone,
a tablet computer,
a pocket computer, and
a notebook,
and wherein the light source (8) is a flashlight or a display.

20. Method according to claim 19, characterized in that the configuration device (15) provides a user interface (22) which is used to display desired actions in relation to a selected preset, wherein the light signal (7) is defined and sent out by means of the user interface (22).
